(19) United States
(12) Patent Application Publication
(10) Pub. No.: US 2013/0161564 A1
(43) Pub. Date: Jun. 27, 2013

(54) NanoStructured Additives to High-Performance Polymers for Use in Radiation Shielding, Protection Against Atomic Oxygen and in Structural Applications

(71) Applicants: Russell Joseph Churhill, Radford, VA (US); Eugene Canlas Aquino, Radford, VA (US); Robert Orwoll, Williamsburg, VA (US); Richard Kiefer, Williamsburg, VA (US); Howard Paul Groger, Gainesville, FL (US)

(72) Inventors: Russell Joseph Churhill, Radford, VA (US); Eugene Canlas Aquino, Radford, VA (US); Robert Orwoll, Williamsburg, VA (US); Richard Kiefer, Williamsburg, VA (US); Howard Paul Groger, Gainesville, FL (US)

(73) Assignee: International Scientific Technologies, Inc., Dublin, VA (US)

(21) Appl. No.: 13/335,423

(22) Filed: Dec. 22, 2011

(51) Int. Cl. G21F 1/10; C07F 5/06; C07F 11/00; C07F 5/02; G02B 5/00; C07F 15/04; B82Y 30/00

(52) U.S. Cl. 252/478; 252/582; 534/15; 556/170; 556/138; 556/57; 564/8; 977/700

(57) ABSTRACT

The invention discloses the incorporation of nanostructured additives into high-performance, hydrogen-rich polymeric materials to provide radiation shields for use against Galactic Cosmic Radiation and Solar Energetic Particles as well as secondary particulate and electromagnetic radiation resulting from nuclear reactions within the shield. Nanostructured materials are defined as having at least one dimension in the nanometer range, and may include metallic and metal-oxide nanoparticles, nanotubes, nanoclays, coated polymeric nanoparticles and pairs of materials forming a nanostructured interface. Functionalization of additives is performed to increase their compatability with polymeric materials. Hydrogen-rich polymers refer to those having interstitial hydrogen or hydrogen-containing materials pendant to the polymer backbone. One embodiment of the invention comprises a radiation shield in which a nanostructured additive capable of shielding against electromagnetic radiation is incorporated with a hydrogen-rich polymer capable of slowing energetic particles. Multifunctional structural shields may also protect against atomic oxygen degradation and control electrostatic discharge.

### STATEMENT REGARDING FEDERALLY SPONSORED RESEARCH OR DEVELOPMENT

The invention described in this application is based on research and development sponsored by the U.S. Federal Government under Contracts and Grants as follows: NASA NNL06AA55P, NASA NNL07ABO1P, NASA NNX08CC75P, NASA NNL08AA17C, NASA NNX09CB33C, and NASA NNX10CF05P. The Government has certain rights in these technologies.

### CROSS-REFERENCE TO RELATED APPLICATIONS

This invention relates to the use of functionalized nanostructured materials together with hydrogen-rich polymers in the manufacture of radiation-shielding, high-performance polymeric materials. The term “nanostructured materials” is defined as a set of materials having at least one dimension in the nanometer range. T hese materials include metallic and metal-oxide nanoparticles, nanotubes, nanoclays, coated polymeric nanoparticles and pairs of materials forming a nanostructured interface. De MEO et al. (2009) teach the use of nanomaterials in radiation shielding and the formation of multifunctional polymers through mixing a radiation-protective material, such as barium, bismuth, tungsten or their compounds, with a powdered polymer, pelletized polymer or liquid solution, emulsion or suspension of a polymer in solvent. DEMEO et al. (2009) recite a wide range of polymers for the radiation-protective shield including polyurethane, polyamide, polyvinyl chloride, polyvinyl alcohol, natural latex, polyethylene, polypropylene, ethylene vinyl acetate, polyisoprene, polystyrene, polysulfone, polyester, acrylonitrile-butadiene-styrene, acrylic, polycarbonate, polyoxymethylene, acetal, polytetrafluoroethylene, ionomers, celluloses, polyetherketone, silicones, epoxy, elastomers and polymer foams. They do not address the means necessary to provide enhanced radiation shielding by high-performance polymers without substantially reducing the thermal and mechanical properties of the high-performance polymer. The use of functionalized additives as well as hydrogen-rich polymers described in the present invention provides an advantage in developing structural materials that can protect against radiation hazards during space travel. The term “hydrogen-rich” refers to a material having interstitial hydrogen or hydrogen-containing materials pendant to the polymer backbone. CALDWELL (2007) describes a means of moderating and stopping neutrons as well as fragments and electromagnetic radiation resulting from neutron-material interaction. The neutron-moderating material may include gadolinium and boron or derivatives thereof dispersed in a polymer binder. Although, CALDWELL (2007) claims hydrogen-rich layers, no attempt was made to design multiple-layer stacks capable of shielding from Galactic Cosmic Radiation (GCR). CALDWELL does not teach an approach to developing radiation shields that can function as structural members, thereby reducing the weight of aerospace structures. The amenability of the present invention to shielding multiple radiation hazards at once is a key advantage. BALLSIEPER (2011) recites a multiple-layer structure including a high atomic number barrier layer, positioned on both sides of low atomic number secondary radiation layers for protection against radiation hazards. BALLSIEPER suggests optional use of reinforcing layers to improve the mechanical strength of the layered structure. In BALLSIEPER, additives that do not significantly reduce polymer thermal and mechanical performance are not addressed. In addition, there is a need for high-performance polymers that are not only mechanically strong, but also fulfill secondary functions, including shielding against electromagnetic and particle radiation, and protection against atomic-oxygen degradation and electrostatic discharge.

### REFERENCE TO SEQUENCE LISTING, A TABLE, OR A COMPUTER PROGRAM LISTING COMPACT DISC APPENDIX

Not Applicable

### BACKGROUND OF THE INVENTION

There is a great need for lightweight structural radiation-shielding materials that are environmentally sound and do not contain elements having high toxicity to animals or man. The advantage of incorporating a means for radiation shielding into a structural polymer is found in the weight reduction associated with multifunctionality. In particular, structural radiation shields having resistance to damage by atomic oxygen would find application in space exploration, resource utilization and colonization. Terrestrial uses of structural radiation shields may be found in the areas of biomedical radiology, and protection of individuals against radiological weapons of mass destruction.

This invention relates to the use of functionalized nanostructured materials as well as hydrogen-rich organic or polymeric materials to serve in the manufacture of radiation shielding, high-performance polymers. Nanostructured additives may include metals, metal-salt complexes, metal oxides and coated polymeric nanoparticles capable of radiation shielding. The selection of additional nanostructured materials can serve to impart multiple functionalities to high-performance polymers. For the purposes of this application, high-performance polymers include poly(arylene ether)s and polyimides, liquid crystalline polymers, and polymers having an inorganic backbone. Polyimides are resistant to acids and alkalis, are resistant to hydrolysis, are flame retardant, maintain good mechanical properties at high temperatures, and have excellent thermal stability. There is a great need to develop high-performance polymers that are not only mechanically strong, but also fulfill secondary functions. T hese functionalities may include shielding against electromagnetic and particle radiation, protection against atomic oxygen degradation, electrostatic discharge control, as well as novel functions realized by modification of the composition and structural features of the additive.

The herein disclosed radiation shielding strategy involves the use of a lightweight element, including hydrogen, lithium, boron or carbon, mixtures thereof or particles containing one or more of these materials (OGAWA et al., 1999) to serve as photon attenuators or particle moderators to reduce the energy of the incoming radiation and nanoparticles or nanostructured materials containing elements with high atomic numbers (high Z) and large particle-capture cross sections to serve as radiation (particle and photon) absorbers. Secondary radiative emission is effectively stopped by the presence of light elements in the vicinity of the secondary emitter. BALLSIEPER (2011) teaches the use of multiple layered structures including both high atomic weight and low atomic weight layers to reduce secondary emission hazards. BALLSEIPER (2011) does not discuss specific methods of functionalizing components of the shield structure for use with high-performance polymers. Polyimides can be made using monomers that are rich in hydrogen atoms. T his can be achieved by increasing the hydrogen content of the high-performance polymers by appending hydrogen-rich groups, such as methyl or tent-butyl (—C(CH₃)₃), to the aromatic backbones (SHULZ et al., 2006). The use of hydrogen-rich polymers in radiation shielding is described by CALDWELL (2007). In the CALDWELL patent, the hydrogen-rich polymer is polyethylene or other materials modified to increase hydrogen content present in the polymer. CALDWELL (2007) does not teach methods of increasing the hydrogen content of high-performance polymers. H U et al. (2006) discuss hydrogen-rich additives for polyimides and poly(arylene ethers). The methods of polymer preparation from these materials are incorporated in the present application by reference.

### BRIEF SUMMARY OF THE INVENTION

The invention involves nanostructuring or molecular ordering of additives in high-performance polymers to provide a multifunctional material that can serve as a radiation shield as well as a structural member. The basis of the invention is the use of materials presenting a large capture or scattering cross section to particles (neutrons or energetic ions) in the vicinity of low molecular weight radiation attenuating materials (hydrogen, lithium, boron or carbon) to provide the functions of particle (neutron or heavy ion) energy attenuation and secondary emission capture within a limited spatial region. There are four components to the invention. These are (1) selection of nanoparticle or nanostructured material chemistry, (2) nanoparticle functionalization and orientation, (3) ensuring interfacial compatibility between the polymer and nanostructured additives, and (4) polymer modification and incorporation of additives providing radiation shielding.

### BRIEF DESCRIPTION OF THE SEVERAL VIEWS OF THE DRAWINGS

FIG. 1 is a schematic representation of a single hydrogenous polymer specimen with an electromagnetic radiation-absorbing nanoparticle additive.

FIG. 2 is a schematic representation of a single hydrogenous polymer specimen with a neutron-absorbing nanoparticle additive.

FIG. 3 is a s chematic representation of a single hydrogenous polymer specimen with a nanoparticle additive that shields against both electromagnetic radiation and neutrons.

FIG. 4 is a schematic representation of a radiation shield incorporating significant features of multiple compositions combined in a single specimen or multiple layers.

### DETAILED DESCRIPTION OF THE INVENTION

### Fabrication of Nanoparticle and Nanostructured Material Chemistry

Nanoparticle or nanostructured materials can be prepared by evaporation, sol-gel processing, directed self-assembly, oxidation or reduction of suitable precursors, electrochemical synthesis or other means. In one embodiment, a nanostructured material can be prepared by mixing hydrogen-rich, high-performance polymer with appropriate metal or metal oxide nanoparticles or metal-ligand cluster. Each of these nanostructured materials can serve a function within a high-performance polymer with the net result that a multifunctional material is formed.

For example, nanostructured boron, borohydrides or boron carbides and other additives can be mixed in a poly(amic acid) solution before imidization to form a polyimide. Piperidine-modified boron nanoparticles can be used with hydrogen-rich polyimides. The poly(amic acid) is made from various combinations of dianhydrides and diamines displaying significant hydrogen content. Bisphenols may also be used after they are converted to diamines. These combinations may include both dianhydrides and two of the diamines to prepare a copolymer that may have more-suitable solubility characteristics than either of the two corresponding homopolymers.

Combinations of metallic nanoparticle additives can be used to shield against various high-energy photon and particulate radiations. Polyimide films are cast from the poly(amic acid) solutions using a doctor blade to set the thickness. Imidization of poly(amic acid) is achieved by oven-processing of the resultant film or refluxing the polymerizing solution using a Dean-Stark trap to remove the water by product.

In a second example, polyimides prepared with oxydianiline (ODA) and 3,3′,4,4′-benzophenone tetracarboxylic dianhydride (BTDA) monomers can be loaded with 10 and 15 wt % tungsten nanoparticles that are treated with benzyl mercaptan. The BTDA and ODA monomers are reacted to form BTDA-ODA polyimide films that are flexible to the point of being creaseable. The nanocomposite films are effective as an electromagnetic radiation shield.

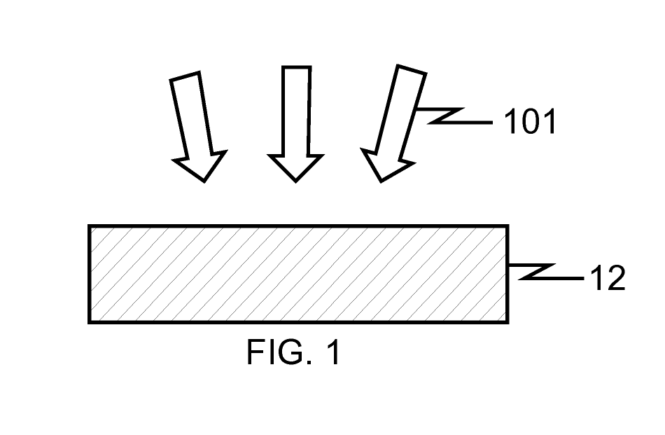

FIG. 1 is a schematic representation of a single hydrogenous polymer specimen of the radiation shield 12 containing electromagnetic radiation-absorbing nanoparticle additive. The constituents of the hydrogenous polymer specimen may include any of a wide range of high-performance polymers, polymer functional-group-forming additives or combinations of low molecular weight nanoparticles, metallorganic materials or low molecular weight fibers. Nanoparticles, including metals, metal oxides and metallic complexes, containing elements with high atomic number (high-Z), which include tungsten, are added to the hydrogenous polymers. A radiation 101 may include Galactic Cosmic Radiation, Solar Energetic Particles, X-rays, Gamma Radiation, particle emitters and particle beams. The radiation 101 is incident on the radiation shield 12. The shield 12 is a single specimen containing multiple components, such as hydrogenous polymers or high-performance polymer precursors, and nanoparticles containing elements having a high atomic number (high-Z), which include tungsten, as shown in FIG. 1. The radiation is incident upon the hydrogenous polymer specimen that serves as a m oderator to slow or attenuate both the incoming high-energy GCR nuclei via Coulombic interactions and energetic neutrons. T he hydrogen-rich polymer specimen may contain fibers, nanoparticles, high aspect ratio nanoparticles, low atomic number (low-Z) nanoparticles, including aluminum and nickel, and high atomic number (high-Z) electromagnetic radiation-absorbing materials to provide enhanced shielding. One advantage of the structure is the amenability of providing a structure serving multiple functions, such as radiation shielding, electrostatic discharge control, and protection against atomic oxygen degradation while not significantly affecting the thermo-mechanical characteristics of high-performance polymers.

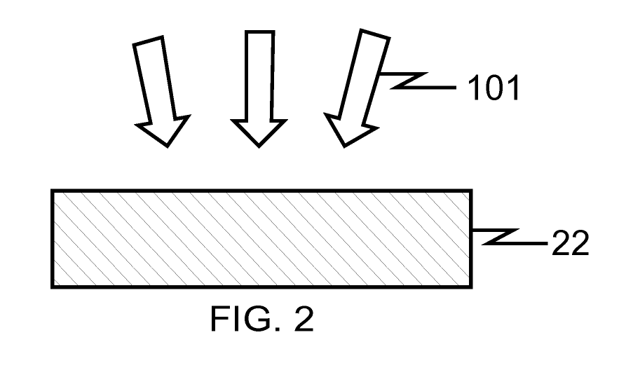

FIG. 2 is a schematic representation of a single hydrogenous polymer specimen of the radiation shield 22 containing a neutron-absorbing nanoparticle additive. A radiation 101 may include Galactic Cosmic Radiation, Solar Energetic Particles, X-rays, Gamma Radiation, particle emitters and particle beams. The radiation 101 is incident on the radiation shield 22. The shield 22 is a single specimen containing multiple components, such as hydrogenous polymers or high-performance polymer precursors, and nanoparticles containing elements having large neutron-capture cross sections, which include boron, as shown in FIG. 2. The radiation is incident upon the hydrogenous polymer specimen that serves as a moderator to slow or attenuate both the incoming high-energy GCR nuclei via Coulombic interactions and energetic neutrons. The hydrogen-rich polymer specimen may contain fibers, nanoparticles, high aspect ratio nanoparticles, low atomic number (low-Z) nanoparticles, including aluminum and nickel, and high atomic number (high-Z) electromagnetic radiation-absorbing materials to provide enhanced shielding. One advantage of the structure is the amenability of providing a structure serving multiple functions, such as radiation shielding, electrostatic discharge control, and protection against atomic oxygen degradation while not significantly affecting the thermo-mechanical characteristics of high-performance polymers.

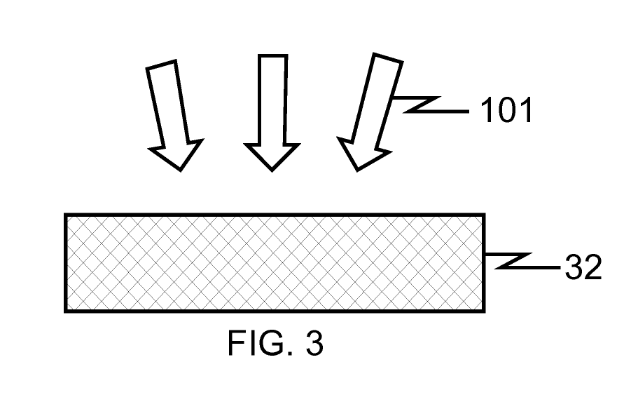

FIG. 3 is a s chematic representation of a single hydrogenous specimen component of the radiation shield 32 containing a nanoparticle additive that shields against both electromagnetic radiation and neutrons. A radiation 101 may include Galactic Cosmic Radiation, Solar Energetic Particles, X-rays, Gamma Radiation, particle emitters and particle beams. The radiation 101 is incident on the radiation shield 32. The shield 32 is a single specimen containing multiple components, such as hydrogenous polymers or high-performance polymer precursors, and nanoparticles containing elements having both a high atomic number (high-Z) and a large neutron-capture cross section, which include gadolinium and samarium, as shown in FIG. 3 The radiation is incident upon the hydrogenous polymer specimen that serves as a moderator to slow or attenuate both the incoming high-energy GCR nuclei via Coulombic interactions and energetic neutrons. The hydrogen-rich polymer specimen may contain fibers, nanoparticles, high aspect ratio nanoparticles, low atomic number (low-Z) nanoparticles, including aluminum and nickel, and a high atomic number (high-Z) electromagnetic radiation-absorbing materials to provide enhanced shielding. One advantage of the structure is the amenability of providing a structure serving multiple functions, such as radiation shielding, electrostatic discharge control, and protection against atomic oxygen degradation while not significantly affecting the thermo-mechanical characteristics of high-performance polymers.

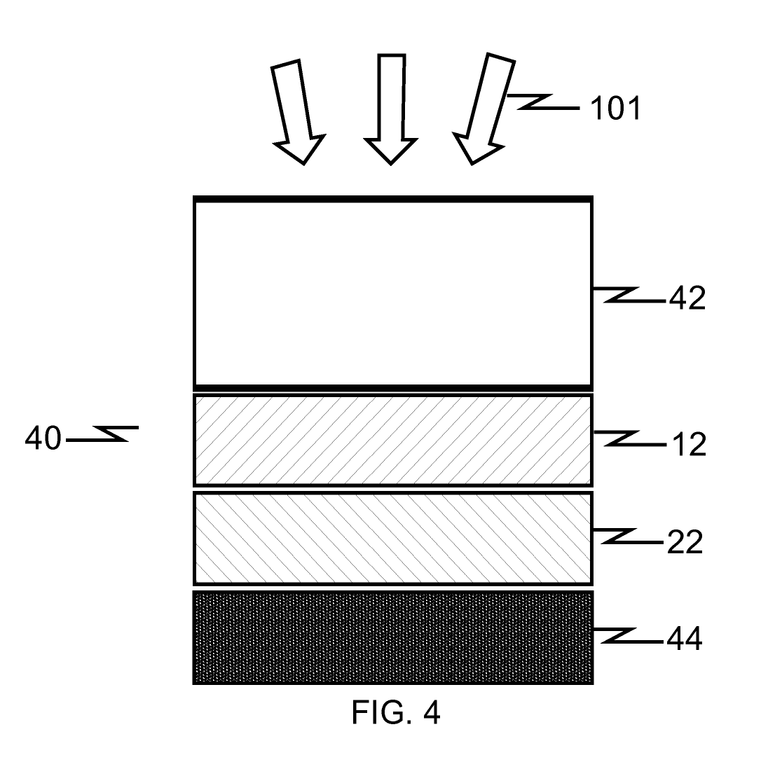

FIG. 4 is a schematic representation of a multi-layered radiation shield 40 incorporating significant features of multiple shield compositions combined in a layered structure. A radiation 101 may include Galactic Cosmic Radiation, Solar Energetic Particles, X-rays, Gamma Radiation, particle emitters and particle beams. The radiation 101 is incident on the multilayered radiation shield 40. Each layer in the shield 40 may be composed of multiple components, such as hydrogenous polymers or high-performance polymer precursors, and nanoparticles containing elements having a high atomic number (high-Z), which include tungsten, a large neutron-capture cross section, which include boron, or having both a high atomic number (high-Z) and a large neutron-capture cross section, which include gadolinium and samarium, as shown in FIG. 4. The radiation is incident upon the outer hydrogenous polymer layer 42 that serves as a moderator to slow or attenuate both the incoming high-energy GCR nuclei via Coulombic interactions and energetic neutrons. Constituents of the structure may include middle shield layer 12 to moderate ionizing electromagnetic radiation as well as middle shield layer 22 to capture neutrons. The shield structure is built over a hydrogenous polymer inner layer 44 that serves further to reduce secondary emissions from fragmentation reactions within the shield. The ordering of the various constituents is not restricted to that shown in FIG. 4. The hydrogen-rich polymer layer may contain fibers, nanoparticles, high aspect ratio nanoparticles, low atomic number (low-Z) nanoparticles, including aluminum and nickel, and high atomic number (high-Z) electromagnetic radiation-absorbing materials to provide enhanced shielding. One advantage of the structure is the amenability of providing a structure serving multiple functions, such as radiation shielding, electrostatic discharge control, and protection against atomic oxygen degradation while not significantly affecting the thermo-mechanical characteristics of high-performance polymers.

Nanoparticle Functionalization Ensuring Interfacial Compatibility between the Additive Material and the High-Performance Polymer

Nanoparticles, nanotubes or other nanostructured materials serve in particle capture and high-energy photon attenuation. T hese nanostructured materials are oriented to provide enhanced capture cross section. Lead-free materials with high neutron-capture cross section include boron, rare earth metals and their oxides, which include gadolinium oxide and samarium oxide, and high atomic number (high-Z) materials, such as tungsten. The nanostructured materials can be oriented via functional inorganic or organic groups linked to the surface of the material. These functional groups also delay or prohibit aggregation of the nanoparticles.

For example, 3-aminopropyltrimethoxysilane (APSi) are used to encapsulate hybrid gadolinium-oxide nanoparticles within a polysiloxane shell (BRIDOT et al., 2007). Phenyltrimethoxysilane (PhSi) can serve to make the inorganic nanoparticles more compatible with aromatic organic polymers. Unmodified samarium-oxide and gadolinium-oxide nanoparticles aggregate and settle within organic solvents, such as chloroform. APSi or PhSi modifications make the gadolinium-oxide nanoparticles more compatible with an organic solvent or polymer. In the case where the nanostructured material is sol-gel derived, an organic material, which include APSi and PhSi, may be added during the polycondensation reaction. In another example, thiol (or mercaptan) agents are used to modify the surface of the metallic nanoparticles, which include aluminum, nickel and tungsten, with an organic ligand, thus increasing the compatibility between the inorganic nanoparticle additive and the organic polymer. In a fourth example, amines are used to modify the surface of boron nanoparticles. Nanoparticle-modifying agents include, but are not limited to phenyltrimethoxysilane, benzyl mercaptan, thiophenol, aniline, benzyl amine, pyridine and piperidine.

The additive material incorporated into the polymer may be an organometallic salt. For example, gadolinium phenylacetate can be prepared by disso lying gadolinium nitrate in dilute ammonia with a weakly basic aqueous solution of sodium phenylacetate. The compatibility of the additive and the high-performance polymer is ensured by the organic nature of the salt.

Polymer Modification and Incorporation of Polymer Additives Enhancing Radiation Shielding and Protection against Atomic Oxygen

High-performance polymers serve as a structural basis for the present invention. Hydrogen-rich polyimides can be formed by the reaction of dianhydride and diamine monomers in dimethylacetamide (DMAc) solvent. Polyimide films are cast from poly(amic acid). The poly(amic) acid is able to be imidized. 2,2-Bis(4-hydroxyphenyl)propane (Bisphenol A or BPA) is reacted with t-butyl methyl ether in the presence of sulfuric acid catalyst to prepare t-butyl substituted BPA monomer. Hydrogen-rich polymers are synthesized using bisphenol, dimine or dianhydride core structures including 2,2-Bis(4-hydroxyphenyl)propane, 1,4-Bis[(4-hydroxyphenyl)-2-propyl]benzene, 1,4-Bis[(4-hydroxy-3,5 -dimethylphenyl)-2-propyl]benzene, and 2,2′-Bis(3,5-di-t-butyl-4-hydroxyphenyl)propane.

Poly(arylene ether)s can be fabricated as polymer-matrix composites, coatings, films and fibers for use in space applications. Commercial examples of high-performance poly(arylene ether)s are poly(ether ether ketone) (PEEK) and poly(ether imide) (Ultem®). Poly(arylene ether)s are resistant to acids and alkalis, are resistant to hydrolysis, are flame retardant, maintain good mechanical properties at high temperatures, and have excellent thermal stability. High-performance poly(arylene ether)s can be modified by adding substituents that are rich in hydrogen atoms. This accomplishes multiple objectives: it renders the polymer a better shielding material against GCR and it would also slow energetic neutrons for subsequent capture by atoms having large thermal neutron-capture cross sections.

One benefit of using a single-specimen structure containing both low atomic number (low-Z) elements, including hydrogen, lithium, boron or carbon, and high atomic number (high-Z) elements, including tungsten, gadolinium and samarium, is the reduced distance for electron and ion transfer among the components of the system. This can be extremely important in reducing the energy of high atomic number, high atomic numbers and high energy (HZE) particles where interaction with high-Z materials can lead to formation of fragments and secondary emission. Secondary radiation, as a result of fragmentation, can be effectively shielded by a low atomic number material in the vicinity of a high atomic number constituent such that there is a minimal distance between point-of-generation of the secondary emission and components enhancing moderation and capture of the radiation. For example, electromagnetic radiation can be attenuated[ using additives containing elements having high atomic number in close proximity to carbon-, boron- or lithium-containing materials. A material providing a stable oxide, such as silicon oxide, may be incorporated in surface layers of the high-performance polymer to provide protection against atomic oxygen degradation. Metallic nanoparticles, including nickel, in a polymer may form a protective oxide layer after exposure to atomic oxygen, thus protecting against atomic oxygen. The incorporation of metallic nanoparticles into the polymer matrix imparts interesting electrical properties that can make the nanocomposite material less prone to accumulating static charge

The present invention combines nanoparticle additives to modify the properties of high-performance polymers. A functionalized nanoparticle or nanostructured material is used in conjunction with one or more hydrogen-rich, high-performance polymers to prepare a nanocomposite as a lightweight effective radiation shield.

The conditions set forth in the foregoing examples are illustrative of various embodiments of the composition and the process of this invention, employing the concept of combining a hydrogen-rich monomer with nanoparticles to develop a high-performance polymer exhibiting multifuctionality specifically including enhanced radiation shielding. Other properties include protection against atomic oxygen degradation and electrostatic discharge. The illustrative conditions may be varied in many ways by one skilled in the art. Substitutions, modifications and alterations are permissible without departing from the spirit and scope of the invention as defined in the following claims.

### REFERENCES CITED

US PATENT DOCUMENTS

| | | |
|---|---|---|
| 7,312,466 | December 2007 | Caldwell |
| 7,476,889 | January 2009 | DeMeo et al. |
| 7,897,949 | March 2011 | Ballsieper |

### Other Publications

Bridot, J.-L., Faure, A.-C., Laurent, S., Rivière, C., Billotey, C., Hiba, B., Janier, M., Josserand, V., Coll, J.-L., Elst, L. V., Muller, R., Roux, S., Perriat, P. and Tillement, O., (2007), “Hybrid Gadolinium Oxide Nanoparticles: Multimodal Contrast Agents for in Vivo Imaging,” J. Am. Chem. Soc.; Vol. 129. No. 16, pp. 5076-5084.
Churchill, R. J., Aquino, E. C., Orwoll, R. A. and Kiefer, R. L., (2006), “Multifunctional Metal-polymer Nanocomposites for Space Applications,” NASA Phase I Final Report, Contract Number NNL06AA55P.
Churchill, R. J., Aquino, E. C., Orwoll, R. A. and Kiefer, R. L., (2007a), “Incorporation of Metallic Nanoparticles in Lightweight Composite Materials for Radiation Shielding in Space-based Monitoring of Nuclear Explosions,” DOE SBIR Phase I, Grant Number DE-FG02-06ER8463, in preparation.
Churchill, R. J., Aquino, E. C., Orwoll, R. A. and Kiefer, R. L., (2007b), “Multifunctional Polymers Incorporating High-Z Neutron-Capture Nanoparticles,” NASA SBIR Phase I Final Report, Contract Number NNL07AB01P.
Churchill, R. J., Aquino, E. C., Orwoll, R. A. and Kiefer, R. L., (2008), “Hydrogen-Rich, Multifunctional Polymeric Nanocomposites for Radiation Shielding,” NASA SBIR Phase Final Report, Contract No. NNX08CC75P.
Churchill, R. J., Aquino, E. C., Groger, H. P., Orwoll, R. A. and Kiefer, R. L., (2009), “Multifunctional Polymers Incorporating High-Z Neutron-Capture Nanoparticles,” NASA SBIR Phase II Final Report, Contract Number NNL08AA17C.
Churchill, R. J., Aquino, E. C., Groger, H. P., Orwoll, R. A. and Kiefer, R. L., (2010), “Multilayer Polymeric Shielding to Protect Humans from Galactic Cosmic Radiation,” NASA SBIR Phase I Final Report, Contract Number NNX10CF05P.
Churchill, R. J., Aquino, E. C., Groger, H. P., Bate, N. G., Orwoll, R. A. and Kiefer, R. L., (2011), “Hydrogen-rich, Multifunctional Polymeric Nanocomposites for Radiation Shielding,” NASA SBIR Phase II Final Report, Contract Number NNX09CB33C.
Hu, L. Y., Yang, S., Miller, A. K., Park, C. S., Plichta, K. A., Rochford, S. J., Schulz, M. E., Orwoll, R. A., and Jensen, B. J., (2006) “Aliphatic/Aromatic Hybrid Polymers for Functionally Graded Radiation Shielding,” High Performance Polymers, Vol. 18, pp. 213-225.
Kiefer, R. L., Orwoll, R. A., Aquino, E. C., Pierce, A. C., Glasgow, M. B. and Thibeault, S. A., (1997), “The Effects of Atomic Oxygen on Polymeric Films Containing Bis(triphenyltin) Oxide,” Poly. Degr. and Stab., Vol. 57, p. 219.
Kiefer, R. L., Weisman, J. L., Orwoll, R. A. and Thibeault, S. A., (2000), “Polymer Additives for Reduced Erosion by Atomic Oxygen,” Polymer Preprints, Vol. 41, No. 1, pp. 329-330.
Kiefer, R. L., Anderson, R. A., Kim, M.-H.Y., Thibeault, S. A., (2003), “Modified Polymeric Materials for Durability in the Atomic Oxygen Space Environment,” Nuclear Instruments and Methods in Physics Research B, Vol. 208, pp. 300-302.
Ogawa, Y., Kiyanagi, Y., and Watanable, N., (1999), “Measurements of Neutronic Performance on a Mixed Cold Moderator of Polyethylene Particles and Liquid Hydrogen,” Journal of Nuclear Science and Technology, Vol. 36, No. 1, pp. 105-107 Downloaded from http://www.jstage.jst.go.jp/article/jnst/36/1/105/pdf May 10, 2009.
Schulz, M., Robert A. Orwoll, R. A., Jensen, B. J., Hu, L. Y., Sha Yang, Adriane K. Miller, Chang S. Park, Kristin A. Plichta, Stephanie J. Rochford, (2006) “Aliphatic/Aromatic Hybrid Polymers for Functionally Graded Radiation Shielding,” High Performance Polymers Vol. 18; p. 213

The claims under this invention are:

1. Nanostructured additives which when added to high-performance, hydrogen-rich polymeric materials can improve the shielding capabilities of the high-performance polymer without significantly affecting the thermal and mechanical properties of that polymer.

2. An additive as that in claim 1, where the additive contain an element having a high atomic number (high-Z) or a large thermal neutron-capture cross section, and serve as electromagnetic radiation attenuator or moderator or to absorb thermal neutrons.

3. An additive as in claim 1 where a metal, metal oxide or metal-salt complex is mixed with the high-performance, hydrogen-rich polymer prior to material formation.

4. An additive as in claim 1 where the metal, metal oxide or metal complex is functionalized using species-selective surface modification prior to mixing with the polymer.

5. An additive as in claim 1 w here the high-performance polymer is a p olyimide or poly(arylene ether).

6. An additive as in claim 1 where a metal, metal oxide or metal-salt complex material is incorporated into the high-performance, hydrogen-rich polymer in order to protect against atomic oxygen degradation.

7. An additive as in claim 1 where a metallic material is incorporated into the high-performance, hydrogen-rich polymer to increase electrical conductivity thereby providing a method to control electrostatic discharge.

8. A radiation shield incorporating metal, metal oxide or metal-salt complex additives into high-performance polymers fabricated using hydrogen-rich monomers

9. A radiation shield as in claim 8 where the metal, metal oxide or metal-salt complex material containing a surface functional group including but not limited to silanes, thiols, amines, epoxides, or other surface covering functional group, which includes phenyltrimethoxysilane, benzyl mercaptan, thiophenol, aniline, benzyl amine, pyridine and piperidine.

10. A radiation shield as in claim 8 where the additive is produced as a separate entity amenable to mixing with the high-performance, hydrogen-rich polymers for further processing.

11. A radiation shield as in claim 8, where the composition of polymers and additives may be designed to shield against Galactic Cosmic Radiation, Solar Energetic Particles, electromagnetic radiation (including X-rays and gamma rays), particle emitters and particle beams.

12. A radiation shield as in claim 8 where the shield can serve additional functions, such as electrostatic discharge control and protection against atomic oxygen degradation, while not affecting the thermal and-mechanical properties of high-performance polymeric material.
